(19) United States
(12) Patent Application Publication
(10) Pub. No.: US 2025/0310452 A1
(43) Pub. Date: Oct. 2, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Asae ORIMOTO, Kanagawa (JP)

(73) Assignee: FUJIFILM Business Innovation Corp., Tokyo (JP)

(21) Appl. No.: 18/778,449

(22) Filed: Jul. 19, 2024

(30) Foreign Application Priority Data
Mar. 27, 2024 (JP) 2024-052424

(51) Int. Cl. H04N 1/00; G06F 8/65

(52) U.S. Cl. CPC H04N 1/00517; G06F 8/65; H04N 1/00925

(57) ABSTRACT

An information processing system includes a processor configured to: simultaneously display at least a part of first displays for setting a first function in a target machine and at least a part of second displays for setting a second function of notifying a user of the target machine of information regarding the first function, on a display unit.

### CROSS-REFERENCE TO RELATED APPLICATIONS

This application is based on and claims priority under 35 USC 119 from Japanese Patent Application No. 2024-052424 filed Mar. 27, 2024.

### BACKGROUND

### (i) Technical Field

The present invention relates to an information processing system, a non-transitory computer readable medium storing a program, and an information processing method.

### (ii) Related Art

JP6460932B discloses an image processing apparatus including a monitoring section having a function of transmitting operation information of the image processing apparatus to a first server and a function of periodically executing a first inquiry of instruction information for the image processing apparatus to the first server, a first control section having a function of displaying, in response to notification based on first instruction information from the first server with respect to the first inquiry from the monitoring section, a message corresponding to the notification in a status display area of a display unit of the image processing apparatus, and a second control section having a function of acquiring page information including the message related to the first instruction information from the first server by using a web browser and displays the page information on the display unit of the image processing apparatus.

### SUMMARY

Aspects of non-limiting embodiments of the present disclosure relate to an information processing system, a non-transitory computer readable medium storing a program, and an information processing method that associate a setting of a first function of a target machine and a setting of a second function of notifying a user of information regarding the first function.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: simultaneously display at least a part of first displays for setting a first function in a target machine and at least a part of second displays for setting a second function of notifying a user of the target machine of information regarding the first function, on a display unit.

### BRIEF DESCRIPTION OF THE DRAWINGS

Exemplary embodiment(s) of the present invention will be described in detail based on the following figures, wherein:

FIG. 1 is an overall configuration diagram of an information processing system according to the present exemplary embodiment;

FIG. 2 is a control block diagram of a hardware configuration of an operation terminal;

FIG. 3 is a functional block diagram of the operation terminal;

FIG. 4 is a schematic diagram of a display unit of the operation terminal;

FIG. 5 is a schematic diagram of the display unit in a case in which a function A is selected via the operation terminal;

FIG. 6 is a schematic diagram of the display unit in a case in which a function B is selected via the operation terminal;

FIG. 7 is a schematic diagram of the display unit in a case in which a predetermined input operation is executed;

FIG. 8 is a schematic diagram of the display unit in a case in which a predetermined input operation is executed;

FIG. 9 is a schematic diagram of the display unit in a case in which a function C is selected via the operation terminal;

FIG. 10 is a schematic diagram of the display unit in a case in which a function D is selected via the operation terminal;

FIG. 11 is a schematic diagram of the display unit in a case in which a predetermined input operation is executed;

FIG. 12 is a schematic diagram of the display unit in a case in which a predetermined input operation is executed;

FIG. 13 is a schematic diagram of the display unit in a case in which a function E is selected via the operation terminal;

FIG. 14 is a diagram showing a function related list; and

FIG. 15 is a flowchart showing processing executed by a CPU of the operation terminal.

### DETAILED DESCRIPTION

Hereinafter, an exemplary embodiment of the present invention will be described in detail with reference to the accompanying drawings.

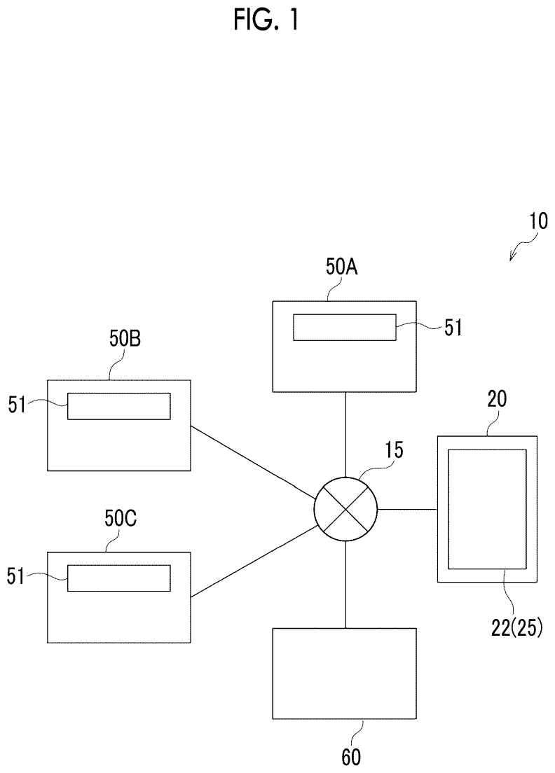

As shown in FIG. 1, an information processing system 10 according to the present exemplary embodiment (hereinafter, referred to as a system 10) includes an operation terminal 20, a plurality of multifunction machines 50A, 50B, and 50C, and an external server 60. The multifunction machines 50A, 50B, and 50C according to the present exemplary embodiment are respectively installed in a plurality of buildings different from each other. Firmware and a plurality of types of application software are implemented in the multifunction machines 50A, 50B, and 50C. The multifunction machines 50A, 50B, and 50C have a plurality of functions including a copy function, a printer function, a scanner function, and a facsimile function. The operation terminal 20 is operated by, for example, an operator belonging to a business operator who performs maintenance and management of the multifunction machines 50A, 50B, and 50C. The operation terminal 20 according to the present exemplary embodiment is a tablet type computer. The operation terminal 20, each of the multifunction machines 50A, 50B, and 50C, and the external server 60 are connected to each other via a wired or wireless communication line 15, such as the Internet or a local area network (LAN), in a mutually communicable manner.

Hereinafter, the operation terminal 20 will be described in detail. As shown in FIG. 1, the operation terminal 20 includes a display unit 22 and an input unit 25. Since the display unit 22 is a touch panel type, the input unit 25 is a part of the display unit 22.

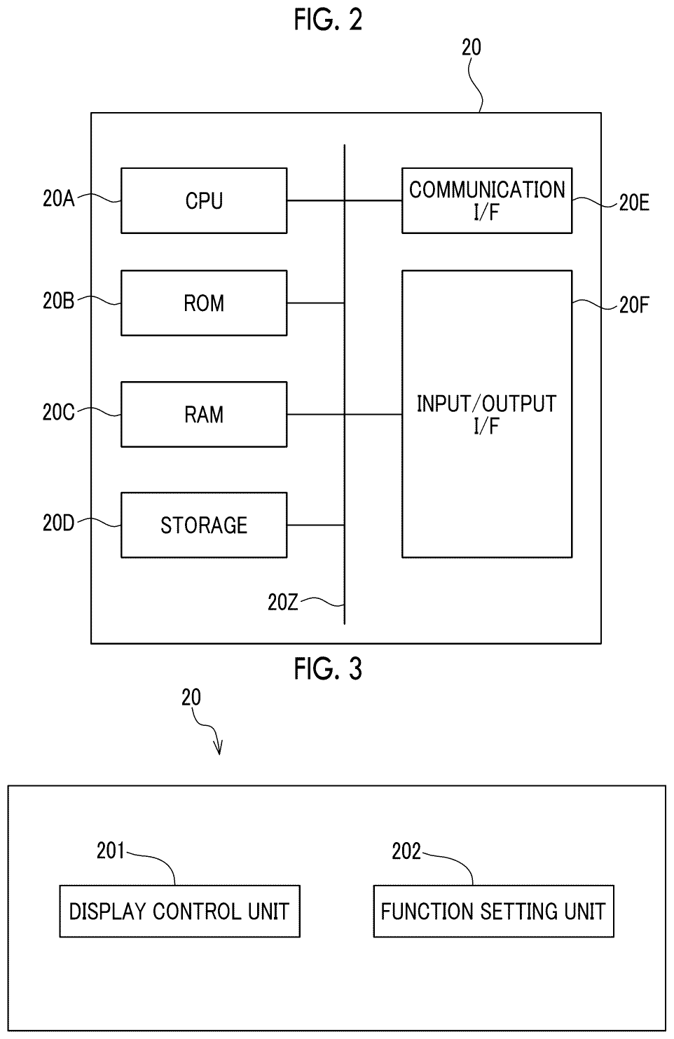

As shown in FIG. 2, the operation terminal 20 includes a central processing unit (CPU, processor) 20A, a read only memory (ROM) 20B, a random access memory (RAM) 20C, a storage 20D, a communication interface (I/F) 20E, and an input/output I/F 20F as a hardware configuration. The CPU 20A, the ROM 20B, the RAM 20C, the storage 20D, the communication I/F 20E, and the input/output I/F 20F are connected in a mutually communicable manner via a bus 20Z.

The CPU 20A is a central operation processing unit, and executes various programs or controls each unit. That is, the CPU 20A reads out a program from the ROM 20B or the storage 20D and executes the program by using the RAM 20C as a work area. The CPU 20A performs control of each of the configurations and various types of operation processing in accordance with the program recorded in the ROM 20B or the storage 20D.

The ROM 20B stores various programs and various data. The RAM 20C temporarily stores the program or the data as the work area. The storage 20D is configured by a storage device such as a hard disk drive (HDD) or a solid state drive (SSD), and stores various programs and various data. The communication I/F 20E is an interface for performing communication with other devices using a wired or wireless method.

FIG. 3 is a block diagram showing an example of a functional configuration of the operation terminal 20. The operation terminal 20 includes a display control unit 201 and a function setting unit 202 as the functional configuration. The display control unit 201 and the function setting unit 202 are realized by the CPU 20A reading out and executing the program stored in the ROM 20B.

The display control unit 201 has a function of displaying predetermined information on the display unit 22 in a case in which the input unit 25 is operated by the operator, in a case in which the operation terminal 20 receives the data through the wireless communication, or in a case in which other predetermined operations are executed with respect to the operation terminal 20.

The function setting unit 202 has a function of transmitting predetermined data to the multifunction machines 50A, 50B, and 50C, and the external server 60 using wireless communication via the communication line 15 in a case in which the operator performs a predetermined operation described below on the input unit 25.

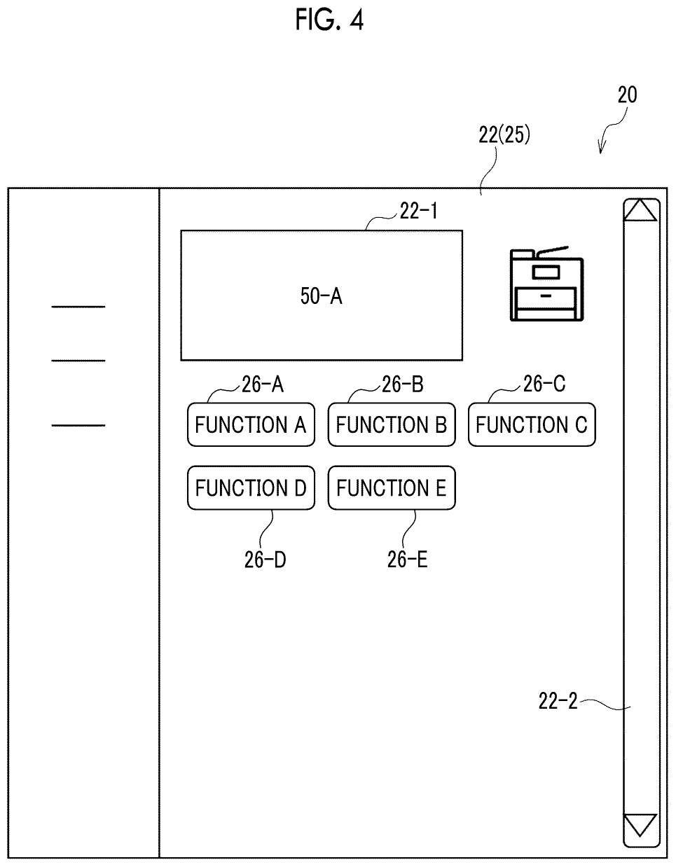

Hereinafter, the functions of the display control unit 201 and the function setting unit 202 will be described in detail with reference to FIGS. 4 to 14.

FIG. 4 shows the display unit 22 of the operation terminal 20. A target machine display area 22-1 is formed in a part of the display unit 22. ID information of the target machines, which are the multifunction machines 50A, 50B, and 50C for which a predetermined function is set by using the operation terminal 20, is displayed in the target machine display area 22-1. The ID information can be input by, for example, the operator using the input unit 25. In the example of FIG. 4, “50-A” which is the ID information of the multifunction machine 50A of FIG. 1 is displayed in the target machine display area 22-1. Further, the display unit 22 includes a scroll operation portion 22-2 for scrolling the information displayed on the display unit 22 in an up-down direction.

Further, a function A selection portion 26-A, a function B selection portion 26-B, a function C selection portion 26-C, a function D selection portion 26-D, and a function E selection portion 26-E, which are a part of the input unit 25, are included in the display unit 22.

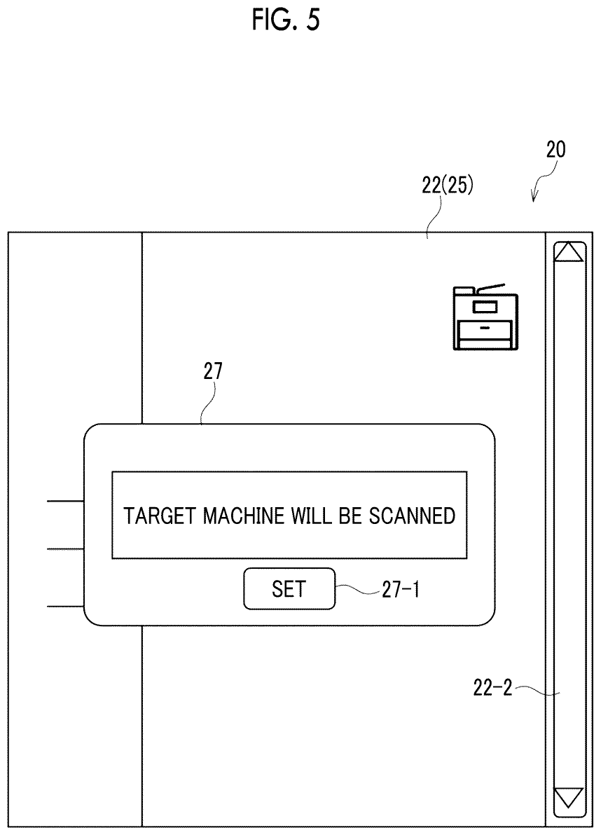

First, a case in which the operator performs a touch operation on the function A selection portion 26-A will be assumed. In this case, the display unit 22 transitions from a state of FIG. 4 to a state of FIG. 5 under the control of the display control unit 201. That is, the target machine display area 22-1, the function A selection portion 26-A, the function B selection portion 26-B, the function C selection portion 26-C, the function D selection portion 26-D, and the function E selection portion 26-E are erased from the display unit 22, and a function description portion 27 is displayed on the display unit 22 instead, as shown in FIG. 5. The function description portion 27 includes a set button 27-1 that is a part of the input unit 25. A sentence representing a content of the function A is displayed in the function description portion 27. The function A according to the present exemplary embodiment is a scan function of acquiring the latest state of the target machine.

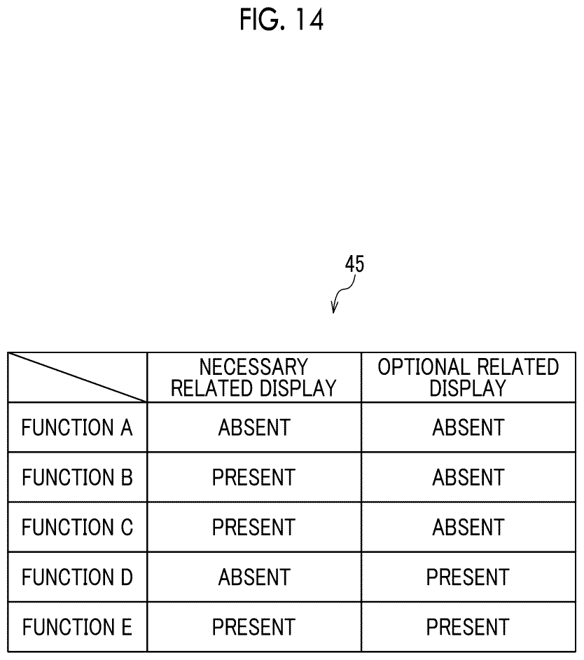

In a case in which the touch operation is performed by the operator on any of the function A selection portion 26-A, the function B selection portion 26-B, the function C selection portion 26-C, the function D selection portion 26-D, or the function E selection portion 26-E, the function setting unit 202 refers to a function related list 45 shown in FIG. 14. The function related list 45 recorded in the ROM 20B or the storage 20D defines a relationship between the functions A, B, C, D, and E and the presence or absence of necessary related display and optional related display. Here, the necessary related display is related display that needs to be displayed on the display unit 22 simultaneously with the function description portion (function description portions 28, 34, and 38). On the other hand, the optional related display is related display that is optionally displayed on the display unit 22 simultaneously with the function description portion (function description portions 36 and 38). As is clear from FIG. 14, the function A to be set for the target machine via the touch operation performed on the function A selection portion 26-A does not have the necessary related display and the optional related display. Therefore, in this case, as shown in FIG. 5, only the function description portion 27 is displayed on the display unit 22.

In a case in which the touch operation is performed on the set button 27-1 of the function description portion 27, predetermined instruction data is transmitted from the operation terminal 20 to the target machine via the communication line 15, and the scan operation is executed in the target machine. That is, the function A is set for the target machine. As a result, the information regarding the latest state of the target machine is transmitted from the target machine to the operation terminal 20 via the communication line 15, and the information regarding the latest state is displayed on the display unit 22 of the operation terminal 20 (not shown). In a case in which a predetermined touch operation is performed on the input unit 25 after this display, the display unit 22 returns to the state of FIG. 4 due to the operation of the display control unit 201.

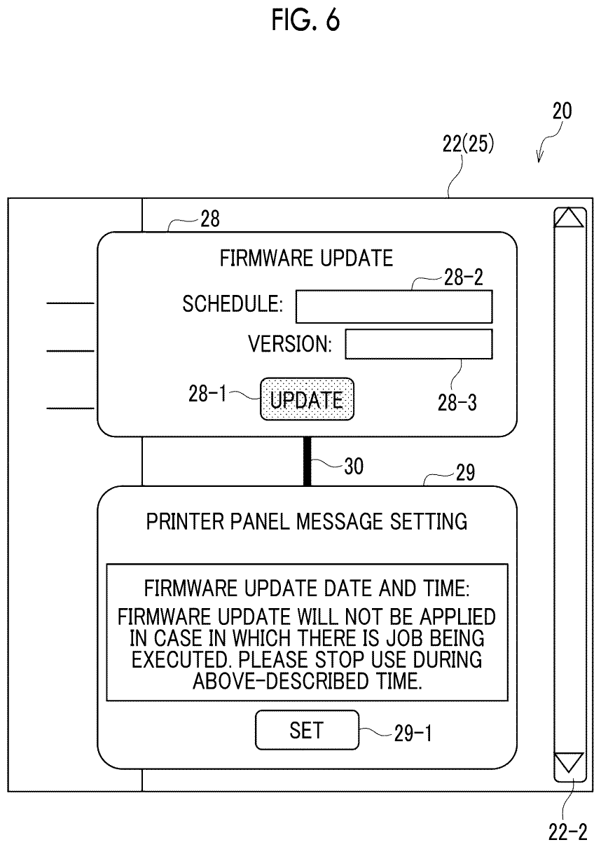

Subsequently, a case in which the operator performs the touch operation on the function B selection portion 26-B will be assumed. In this case, the display unit 22 transitions from the state of FIG. 4 to a state of FIG. 6 under the control of the display control unit 201. That is, the target machine display area 22-1, the function A selection portion 26-A, the function B selection portion 26-B, the function C selection portion 26-C, the function D selection portion 26-D, and the function E selection portion 26-E are erased from the display unit 22, and the function description portion 28 is displayed on the display unit 22 instead, as shown in FIG. 6. The function description portion 28 includes an update button 28-1 that is a part of the input unit 25. The function description portion 28 includes a schedule display portion 28-2 that represents a date and time when the function B is set for the target machine, and a version display portion 28-3 that represents version information of the firmware to be installed in the target machine by setting the function B. That is, the function B is a function of installing the latest firmware in the target machine.

Further, the function setting unit 202 refers to the function related list 45. As is clear from FIG. 14, the function B to be set for the target machine via the touch operation performed on the function B selection portion 26-B has the necessary related display. Therefore, in this case, as shown in FIG. 6, the function setting unit 202 reads predetermined data from the ROM 20B, and the display control unit 201 displays a function description portion 29 and a relevance indicator 30 in addition to the function description portion 28 on the display unit 22. The function description portion 29, which is the necessary related display, displays information regarding an update date and time of the firmware in the target machine and a usage prohibition time of the target machine caused by the update of the firmware. Further, the relevance indicator 30, which has a black linear shape, connects the function description portion 28 and the function description portion 29.

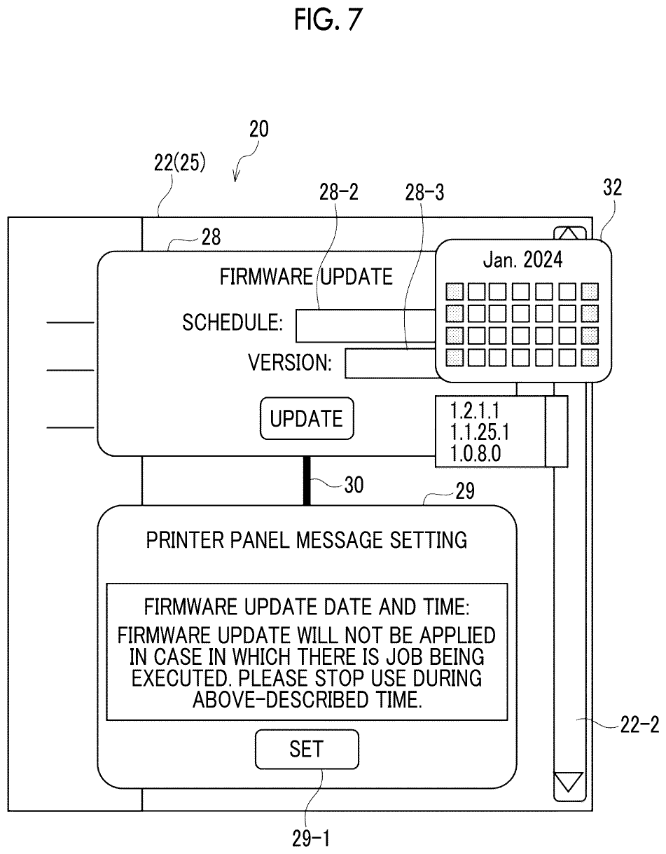

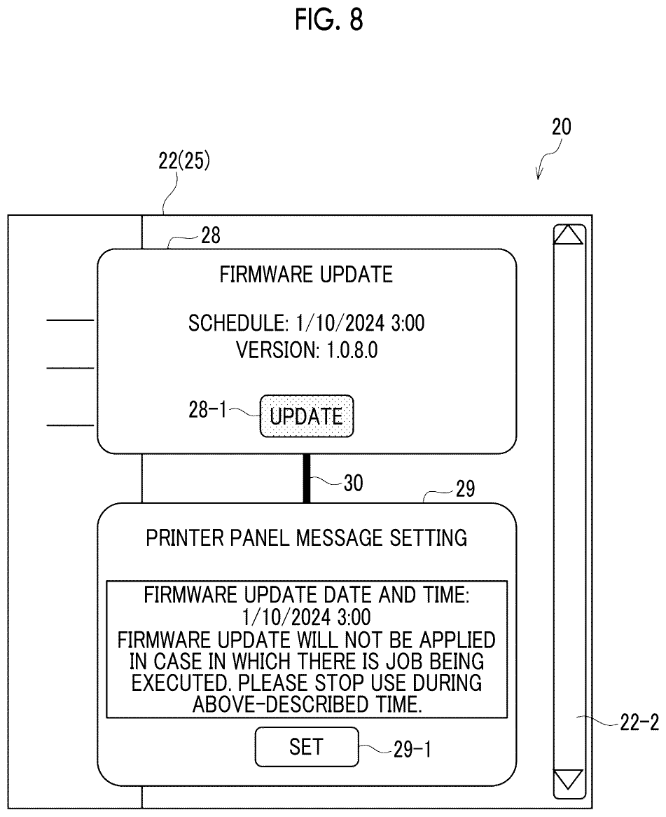

In a case in which the touch operation is performed on the schedule display portion 28-2 or the version display portion 28-3 in this state, the display unit 22 transitions from the state of FIG. 6 to a state of FIG. 7 under the control of the display control unit 201. That is, a keypad display portion 32 is displayed on the display unit 22. The operator performs the touch operation on the keypad display portion 32, whereby the predetermined information is input to the schedule display portion 28-2 and the version display portion 28-3. As a result, the display unit 22 transitions from the state of FIG. 7 to a state of FIG. 8 under the control of the display control unit 201. As shown in FIG. 8, the information input to the schedule display portion 28-2 is reflected in a description sentence of the function description portion 29. The displayed description sentence can be appropriately edited by the operator. Here, the edited description sentence is a sentence notified to the user of the multifunction machine 50 in a case in which the function indicated by the function description portion 28 is executed.

In a case in which the touch operation is performed on a set button 29-1 in this state, the setting for notifying the user of the description sentence of the function description portion 29 is completed. In a case in which the setting is completed, the touch operation on the update button 28-1 is valid, and the function B is set for the target machine. That is, in a case in which the touch operation is performed on the update button 28-1 after the touch operation is performed on the set button 29-1, the external server 60 that has received the predetermined instruction data from the operation terminal 20 transmits the firmware to the target machine at the date and time displayed in the function description portion 28, and the target machine executes the download of the firmware and the update of the firmware. That is, the function B is set for the target machine. Further, immediately after the touch operation is performed on the update button 28-1, a message described in the function description portion 29 is transmitted from the operation terminal 20 to the target machine, and the message is displayed on a display unit 51 of the target machine. Thereafter, the display control unit 201 returns the display unit 22 to the state of FIG. 4.

On the other hand, in a case in which the touch operation is performed on the update button 28-1 before the touch operation is performed on the set button 29-1 in the state shown in FIG. 8, the touch operation on the update button 28-1 is invalid. That is, the display unit 22 maintains the state of FIG. 8 and does not return to the state of FIG. 4. Therefore, in this case, the function B is not set for the target machine.

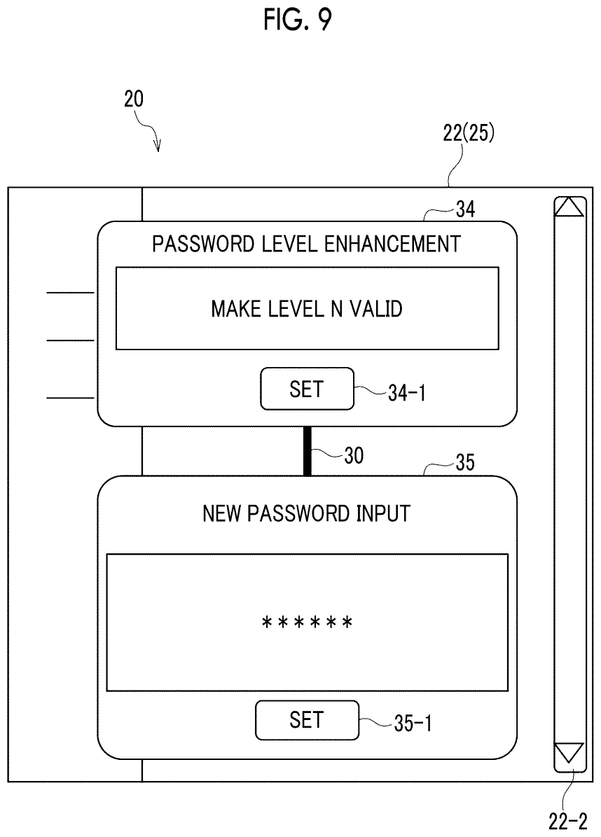

Subsequently, a case in which the operator performs the touch operation on the function C selection portion 26-C will be assumed. In this case, the display unit 22 transitions from the state of FIG. 4 to a state of FIG. 9 under the control of the display control unit 201. That is, the target machine display area 22-1, the function A selection portion 26-A, the function B selection portion 26-B, the function C selection portion 26-C, the function D selection portion 26-D, and the function E selection portion 26-E are erased from the display unit 22, and the function description portion 34 is displayed on the display unit 22 instead, as shown in FIG. 9. The function description portion 34 includes a set button 34-1 that is a part of the input unit 25. The function description portion 34 displays information representing that a password level of the target machine is enhanced. That is, the function C is a function of enhancing the password level of the target machine.

Further, the function setting unit 202 refers to the function related list 45. As is clear from FIG. 14, the function C to be set for the target machine via the touch operation performed on the function C selection portion 26-C has the necessary related display. Therefore, in this case, as shown in FIG. 9, the function setting unit 202 reads the predetermined data from the ROM 20B, and the display control unit 201 displays a function description portion 35 and the relevance indicator 30 in addition to the function description portion 34 on the display unit 22. A new password that satisfies a required password level can be input to the function description portion 35, which is the necessary related display. Although not shown, in a case in which the touch operation is performed on the function description portion 35, the keypad display portion 32 is displayed in the vicinity of the function description portion 35. Therefore, the operator can input the password to the function description portion 35 by using the keypad display portion 32. The function description portion 35 includes a set button 35-1 that is a part of the input unit 25. Further, the relevance indicator 30 connects the function description portion 34 and the function description portion 35.

In a case in which the touch operation is performed on the set button 35-1 in this state, the touch operation on the set button 34-1 is valid by the control of the function setting unit 202. In other words, even in a case in which the touch operation is performed on the set button 34-1 before the touch operation is performed on the set button 35-1, the function C is not set for the target machine.

In a case in which the touch operation is performed on the set button 34-1 after the touch operation is performed on the set button 35-1, information regarding the new password is transmitted from the operation terminal 20 to the target machine, and the target machine executes update processing of the new password. Further, the information regarding the new password displayed on the function description portion 35 is displayed on the display unit 51. That is, the function C is set for the target machine. Thereafter, the display unit 22 returns to the state of FIG. 4 due to the operation of the display control unit 201.

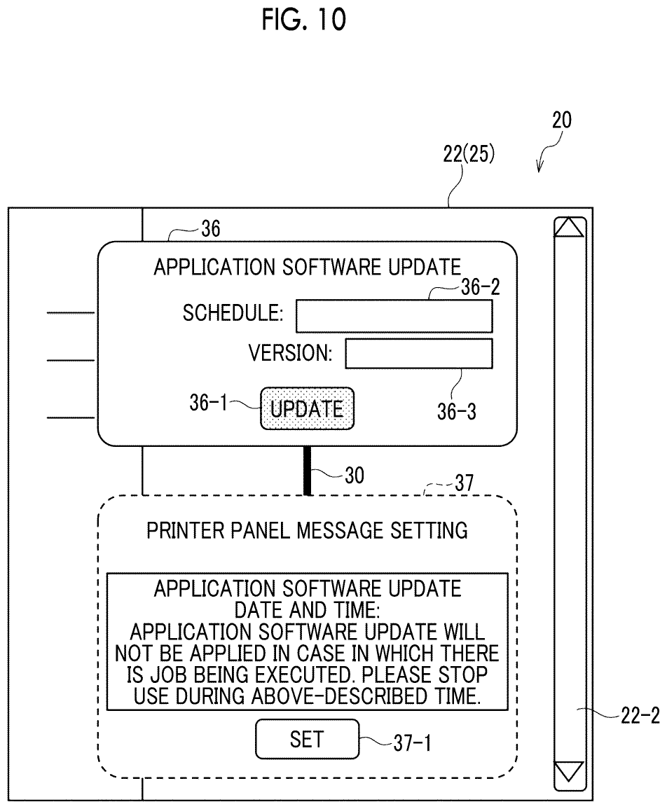

Subsequently, a case in which the operator performs the touch operation on the function D selection portion 26-D will be assumed. In this case, the display unit 22 transitions from the state of FIG. 4 to a state of FIG. 10 under the control of the display control unit 201. That is, the target machine display area 22-1, the function A selection portion 26-A, the function B selection portion 26-B, the function C selection portion 26-C, the function D selection portion 26-D, and the function E selection portion 26-E are erased from the display unit 22, and the function description portion 36 is displayed on the display unit 22 instead, as shown in FIG. 10. The function description portion 36 includes an update button 36-1 that is a part of the input unit 25. A schedule display portion 36-2 representing a date and time when the function D is set for the target machine and a version display portion 36-3 representing the version information of the application software to be installed in the target machine by setting the function D are formed in the function description portion 36. That is, the function D is a function of installing the latest application software in the target machine.

Further, the function setting unit 202 refers to the function related list 45. As is clear from FIG. 14, the function D to be set for the target machine via the touch operation performed on the function D selection portion 26-D has the optional related display. Therefore, in this case, as shown in FIG. 10, the function setting unit 202 reads the predetermined data from the ROM 20B, and the display control unit 201 displays a function description portion 37 and the relevance indicator 30 in addition to the function description portion 36 on the display unit 22. The function description portion 37, which is the optional related display, displays the update date and time of the application software in the target machine and information regarding the usage prohibition time of the target machine caused by the update of the application software. Further, the relevance indicator 30, which has a black linear shape, connects the function description portion 36 and the function description portion 37. Since the function description portion 37 is the optional related display, an outer shape of the function description portion 37 is displayed by a broken line on the display unit 22.

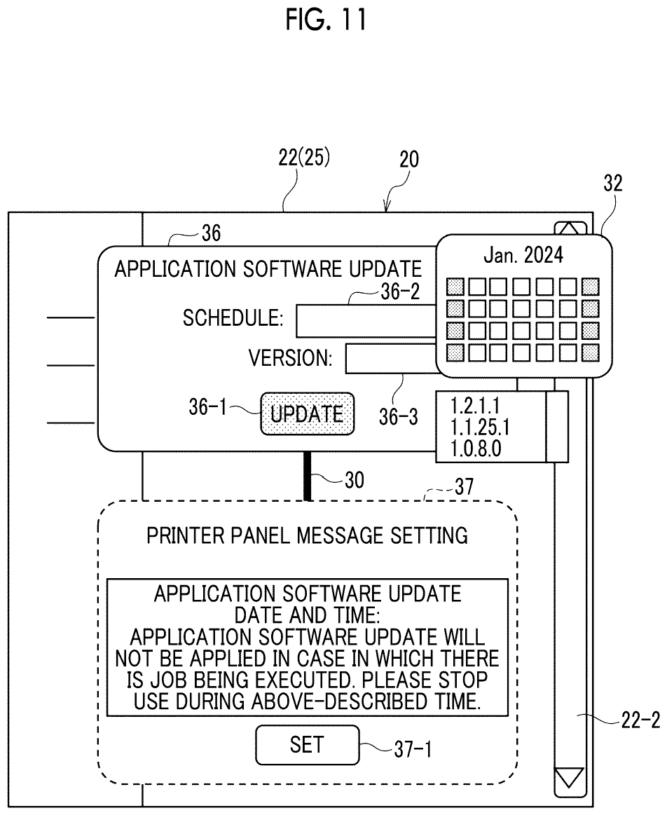

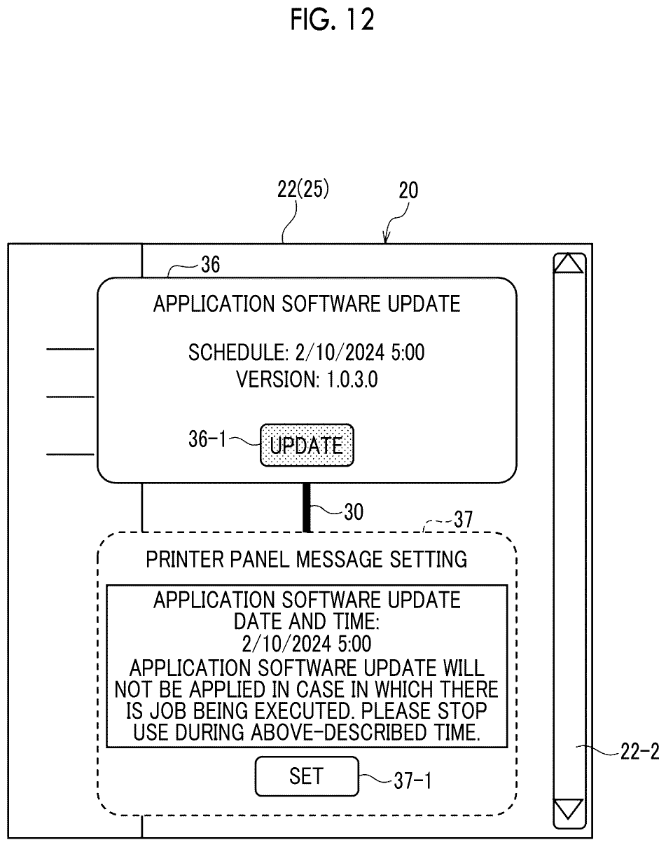

In a case in which the touch operation is performed on the schedule display portion 36-2 or the version display portion 36-3 in this state, the display unit 22 transitions from the state of FIG. 10 to a state of FIG. 11 under the control of the display control unit 201. That is, the keypad display portion 32 is displayed on the display unit 22. The operator performs the touch operation on the keypad display portion 32, whereby the predetermined information is input to the schedule display portion 36-2 and the version display portion 36-3. As a result, the display unit 22 transitions from the state of FIG. 11 to a state of FIG. 12 under the control of the display control unit 201. As shown in FIG. 12, the information input to the schedule display portion 36-2 is reflected in a description sentence of the function description portion 37. The displayed description sentence can be appropriately edited by the operator. Here, the edited description sentence is a sentence notified to the user of the multifunction machine 50 in a case in which the function indicated by the function description portion 36 is executed.

In a case in which the touch operation is performed on the update button 36-1 in this state, the setting for notifying the user of the description sentence of the function description portion 29 is completed. After the setting is completed, the external server 60 that has received the predetermined instruction data from the operation terminal 20 transmits the application software to the target machine at the date and time displayed in the function description portion 36, and the target machine executes the download of the application software and the update of the application software. That is, the function D is set for the target machine. Thereafter, the display unit 22 returns to the state of FIG. 4 due to the operation of the display control unit 201.

On the other hand, in a case in which the touch operation is performed on the update button 36-1 after the touch operation is performed on the set button 37-1 in the state shown in FIG. 12, the external server 60 that has received the predetermined instruction data from the operation terminal 20 transmits the application software to the target machine at the date and time displayed in the function description portion 36, and the target machine executes the download of the application software and the update of the application software. Further, immediately after the touch operation is performed on the update button 36-1, a message described in the function description portion 37 is transmitted from the operation terminal 20 to the target machine, and the message is displayed on the display unit 51 of the target machine. That is, the function D is set for the target machine.

In this way, processing of setting the function D for the target machine via the touch operation performed on the update button 36-1 is executed regardless of the presence or absence of the touch operation on the set button 37-1. That is, the processing of setting the function D for the target machine is executed in a case in which the touch operation is performed on the update button 36-1, regardless of whether or not a message described in the set button 37-1 is transmitted from the operation terminal 20 to the target machine.

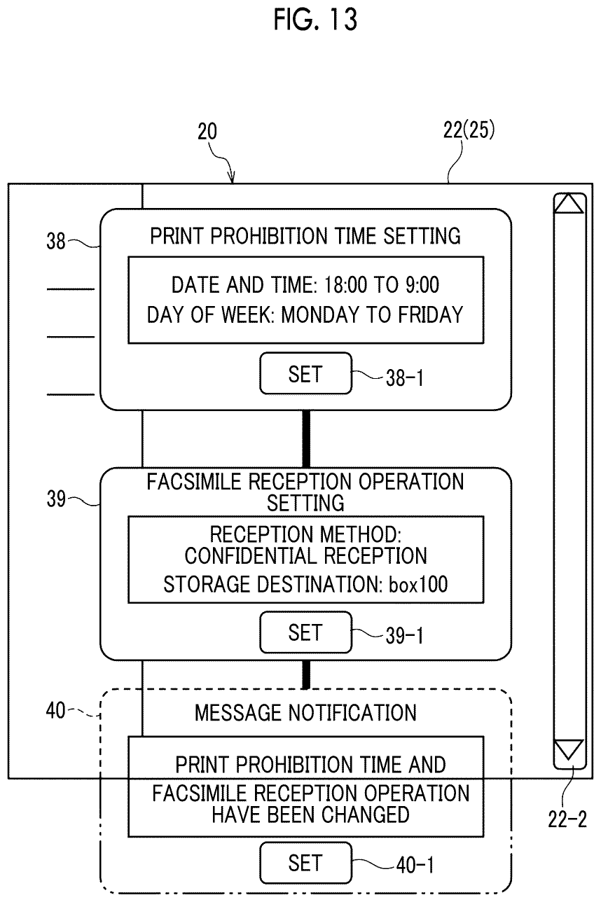

Subsequently, a case in which the operator performs the touch operation on the function E selection portion 26-E will be assumed. In this case, the display unit 22 transitions from the state of FIG. 4 to a state of FIG. 13 under the control of the display control unit 201. That is, the target machine display area 22-1, the function A selection portion 26-A, the function B selection portion 26-B, the function C selection portion 26-C, the function D selection portion 26-D, and the function E selection portion 26-E are erased from the display unit 22, and the function description portion 38 is displayed on the display unit 22 instead, as shown in FIG. 13. The function description portion 38 includes a set button 38-1 that is a part of the input unit 25. Information representing a date and time when the function E is set is displayed in the function description portion 38. That is, the function E is a function of stopping a print function of the target machine.

Further, the function setting unit 202 refers to the function related list 45. As is clear from FIG. 14, the function E to be set for the target machine via the touch operation performed on the function E selection portion 26-E has the necessary related display and the optional related display. Therefore, in this case, as shown in FIG. 13, the function setting unit 202 reads the predetermined data from the ROM 20B, and the display control unit 201 displays the function description portions 39 and 40 and two relevance indicators 30 in addition to the function description portion 38 on the display unit 22. The function description portion 39, which is the necessary related display, displays a method of accessing a recording apparatus that stores reception information as confidential information in a case in which the target machine executes a reception operation of a facsimile during a print prohibition time slot in the target machine. In addition, the function description portion 40, which is the optional related display, displays information representing that the print prohibition time slot in the target machine and the reception operation of the facsimile are changed. Since the function description portion 40 is the optional related display, an outer shape of the function description portion 40 is displayed by a broken line on the display unit 22. The function description portion 38 and the function description portion 39 are connected to each other by one relevance indicator 30, and the function description portion 39 and the function description portion 40 are connected to each other by the other relevance indicator 30.

In a case in which the three function description portions (function description portions 38, 39, and 40) and the two relevance indicators 30 are displayed on the display unit 22 as described above, as shown in FIG. 13, all of the three function description portions and the two relevance indicators 30 cannot be displayed simultaneously on the display unit 22. For example, in FIG. 13, an upper part of the function description portion 40 is located in the display unit 22, while a lower part of the function description portion 40 is not located in the display unit 22. That is, the lower part of the function description portion 40 in FIG. 13 is not displayed on the display unit 22. Therefore, in this case, the lower part of the function description portion 40 is displayed on the display unit 22 by scrolling the image displayed on the display unit 22 in the up-down direction using the scroll operation portion 22-2 of the display unit 22. That is, the operator can recognize all of the three function description portions and the two relevance indicators 30 by using the scroll operation portion 22-2.

In a case in which the touch operation is performed on the set button 38-1 after the touch operation is performed on the set button 39-1 and before the touch operation is performed on the set button 40-1 in this state, the processing of setting the function E for the target machine is executed. That is, the print function of the target machine is invalid during the print prohibition time slot, the information regarding the confidential reception of the facsimile in the print prohibition time slot is transmitted, and the information is displayed on the display unit 51 of the target machine. Thereafter, the display unit 22 returns to the state of FIG. 4 due to the operation of the display control unit 201.

On the other hand, in a case in which the touch operation is performed on the set button 38-1 after the touch operation is performed on the set button 39-1 and the set button 40-1 in the state shown in FIG. 13, the print function of the target machine during the print prohibition time slot is invalid, the information regarding the confidential reception of the facsimile during the print prohibition time slot is transmitted, the information is displayed on the display unit 51 of the target machine, a message described in the function description portion 40 is further transmitted from the operation terminal 20 to the target machine, and the information is displayed on the display unit 51 of the target machine. Thereafter, the display unit 22 returns to the state of FIG. 4 due to the operation of the display control unit 201.

The function description portions 27, 28, 34, 36, and 38 displayed on the display unit 22 due to the touch operation performed on the function A selection portion 26-A, the function B selection portion 26-B, the function C selection portion 26-C, the function D selection portion 26-D, or the function E selection portion 26-E will be referred to as a “first display”. Further, the function description portions 29, 35, 37, 39, and 40 displayed on the display unit 22 due to the display of the first display on the display unit 22 and the reference to the function related list 45 will be referred to as a “second display”. Further, the touch operation on the set button 27-1, the update button 28-1, the set button 34-1, the update button 36-1, and the set button 38-1 will be referred to as a “first operation”, and the touch operation on the set button 29-1, the set button 35-1, the set button 37-1, the set button 39-1, and the set button 40-1 will be referred to as a “second operation”. Further, the function represented by the first display and set for the target machine will be referred to as a “first function”. In addition, the function represented by the second display and being for displaying the information regarding the first function on the display unit 51 of the target machine will be referred to as a “second function”.

Next, the operation of the system 10 having the above-described configuration will be described.

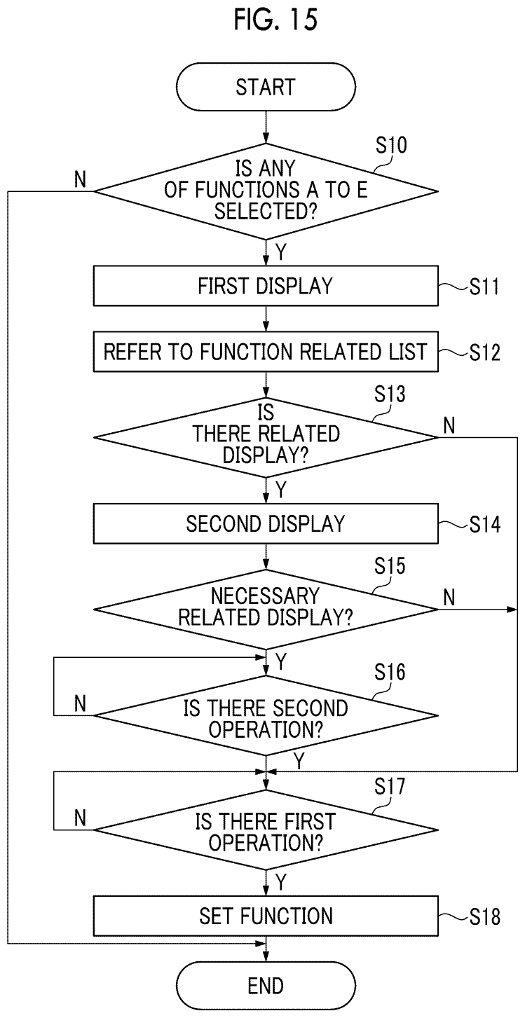

The CPU 20A of the operation terminal 20 repeatedly executes processing of a flowchart of FIG. 15 for each operation period.

First, in step S10 (hereinafter, a text of step will be omitted), the CPU 20A determines whether or not the touch operation is performed on the function A selection portion 26-A, the function B selection portion 26-B, the function C selection portion 26-C, the function D selection portion 26-D, or the function E selection portion 26-E displayed on the display unit 22.

In a case in which Yes is determined in S10, the CPU 20A proceeds to S11 to display the first display on the display unit 22.

In a case in which the processing of S11 ends, the CPU 20A proceeds to S12 and refers to the function related list 45.

In a case in which the processing of S12 ends, the CPU 20A proceeds to S13 and determines whether or not the first display displayed on the display unit 22 has at least one of the necessary related display or the optional related display.

In a case in which Yes is determined in S13, the CPU 20A proceeds to $14 to display the second display on the display unit 22.

In a case in which the processing of S14 ends, the CPU 20A proceeds to S15 and determines whether or not the necessary related display is included in the related display determined as Yes in S13.

In a case in which Yes is determined in S15, the CPU 20A proceeds to S16 and determines whether or not the second operation is executed.

In a case in which Yes is determined in S16, the CPU 20A proceeds to S17 and determines whether or not the first operation is executed.

On the other hand, in a case in which No is determined in S13 or S15, the CPU 20A proceeds to S17 and determines whether or not the first operation is executed.

In a case in which Yes is determined in S17, the CPU 20A proceeds to S18 and sets the predetermined function for the target machine. For example, in a case in which the touch operation is performed on the function B selection portion 26-B in S10, the target machine executes the download of the firmware and the update of the firmware. Further, the message described in the function description portion 29 is displayed on the display unit 51 of the target machine.

In a case where No is determined in S10 or in a case where the processing of S18 ends, the CPU 20A temporarily ends the processing of the flowchart of FIG. 15.

As described above, in the system 10 according to the present exemplary embodiment, in a case in which the touch operation is performed on the function B selection portion 26-B, the function C selection portion 26-C, the function D selection portion 26-D, or the function E selection portion 26-E of the display unit 22, at least a part of the first displays for setting the first function for the target machine and at least a part of the second displays for setting the second function of notifying the user of the target machine of the information regarding the first function are simultaneously displayed on the display unit 22. Therefore, the system 10 associates the setting of the first function and the setting of the second function for the target machine with each other. Therefore, in a case in which the touch operation is performed on the function B selection portion 26-B, the function C selection portion 26-C, the function D selection portion 26-D, or the function E selection portion 26-E, the description related to the second function is displayed on the display unit 51 of the target machine. Therefore, the user who views the display unit 51 of the target machine can recognize the first function and the second function.

Further, in the system 10, the first function in a case in which the touch operation is performed on the function B selection portion 26-B or the function D selection portion 26-D of the display unit 22 is a function accompanied by a time during which the target machine is not usable by the user of the target machine. Further, in this case, the notification to the user of the information regarding the first function executed by the second function is notification regarding the time during which the target machine is not usable. Therefore, in a case in which the touch operation is performed on the function B selection portion 26-B or the function D selection portion 26-D of the display unit 22, the system 10 associates the setting of the first function accompanied by the time during which the target machine is not usable by the user and the setting of the second function of notifying the user of the time during which the target machine is not usable. Therefore, in a case in which the touch operation is performed on the function B selection portion 26-B or the function D selection portion 26-D, the user who views the display unit 51 of the target machine can recognize the time during which the target machine is not usable.

Further, in a case in which the touch operation is performed on the function B selection portion 26-B, the function C selection portion 26-C, or the function D selection portion 26-D of the display unit 22, all of the first displays and all of the second displays are simultaneously displayed on the display unit 22. Therefore, in this case, the operator who operates the operation terminal 20 may more easily recognize the relevance between the first display and the second display than in a case in which only a part of the first displays or only a part of the second displays is simultaneously displayed on the display unit 22.

Further, in a case in which the touch operation is performed on the function B selection portion 26-B, the function C selection portion 26-C, the function D selection portion 26-D, or the function E selection portion 26-E of the display unit 22, the system 10 displays the relevance indicator 30 indicating that the first display and the second display have the relevance to each other on the display unit 22. Therefore, the system 10 makes it easier for the operator of the operation terminal 20 to recognize the relevance between the first display and the second display than in a case in which only the first display and the second display are displayed on the display unit 22.

Further, the relevance indicator 30 is a black linear figure that connects the first display and the second display. Therefore, the system 10 makes it easier for the operator of the operation terminal 20 to recognize the relevance between the first display and the second display than in a case in which the relevance indicator is separated from the first display and the second display.

Further, in a case in which the touch operation is performed on the function B selection portion 26-B or the function C selection portion 26-C of the display unit 22, in a case in which the first operation for confirming the content of the first function based on the first display and the second operation for confirming the content of the second function based on the second display are executed, the system 10 confirms the content of the first function and the content of the second function. Therefore, the system 10 may prevent a situation in which only one of the content of the first function or the content of the second function is confirmed and the other is not confirmed, due to the operation of the operation terminal 20 in a case in which the touch operation is performed on the function B selection portion 26-B or the function C selection portion 26-C.

Further, the system 10 allows the first operation to be executed after the second operation is executed in a case in which the touch operation is performed on the function B selection portion 26-B or the function C selection portion 26-C of the display unit 22. Therefore, in a case in which the touch operation is performed on the function B selection portion 26-B or the function C selection portion 26-C, the system 10 may always confirm the content of the second function in a case in which the content of the first function is confirmed by operating the operation terminal 20.

Although the system 10 and the program according to the present exemplary embodiment have been described with reference to the accompanying drawings, the system 10 and the program according to the present exemplary embodiment are not limited to the illustrated examples, and can be appropriately designed and changed within a range not departing from the gist of the present invention.

For example, the operation terminal 20 may be a personal computer or a smartphone.

For example, the display unit 22 may simultaneously display only a part of the first displays and only a part of the second displays.

For example, the target machine may have the same function as the operation terminal 20. In this case, for example, the function A selection portion 26-A, the function B selection portion 26-B, the function C selection portion 26-C, the function D selection portion 26-D, and the function E selection portion 26-E are displayed on the touch panel type display unit 51 of the target machine. Therefore, the operator can set the first function and the second function for the target machine by performing the predetermined operation on the display unit 51 of the target machine.

The shape of the relevance indicator 30 may be a shape different from the above-described example. Further, the relevance indicator 30 may be separated from the first display and the second display.

### Supplementary Note

(((1)))

An information processing system comprising:
a processor configured to:
   simultaneously display at least a part of first displays for setting a first function in a target machine and at least a part of second displays for setting a second function of notifying a user of the target machine of information regarding the first function, on a display unit.
      (((2)))

The information processing system according to (((1))),
wherein the first function is a function accompanied by a time during which the target machine is not usable by the user, and
the notification to the user of the information regarding the first function is notification regarding the time during which the target machine is not usable.
   (((3)))

The information processing system according to (((1))) or (((2))), wherein the processor is configured to:
simultaneously display all of the first displays and all of the second displays on the display unit.
   (((4)))

The information processing system according to any one of (((1))) to (((3))), wherein the processor is configured to:
display a relevance indicator indicating that the first display and the second display have relevance to each other on the display unit.
   (((5)))

The information processing system according to (((4))),
wherein the relevance indicator is a figure that connects the first display and the second display.
   (((6)))

The information processing system according to any one of (((1))) to (((5))), wherein the processor is configured to:
in a case in which a first operation for confirming a content of the first function based on the first display and a second operation for confirming a content of the second function based on the second display are executed, confirm the content of the first function and the content of the second function.
   (((7)))

The information processing system according to (((6))), wherein the processor is configured to:
allow the first operation to be executed after the second operation is executed.
   (((8)))

A program causing a computer to execute a process comprising:
simultaneously displaying at least a part of first displays for setting a first function in a target machine and at least a part of second displays for setting a second function of notifying a user of the target machine of information regarding the first function, on a display unit.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
simultaneously display at least a part of first displays for setting a first function in a target machine and at least a part of second displays for setting a second function of notifying a user of the target machine of information regarding the first function, on a display unit.

2. The information processing system according to claim 1,
wherein the first function is a function accompanied by a time during which the target machine is not usable by the user, and
the notification to the user of the information regarding the first function is notification regarding the time during which the target machine is not usable.

3. The information processing system according to claim 1, wherein the processor is configured to:
simultaneously display all of the first displays and all of the second displays on the display unit.

4. The information processing system according to claim 2, wherein the processor is configured to:
simultaneously display all of the first displays and all of the second displays on the display unit.

5. The information processing system according to claim 1, wherein the processor is configured to:
display a relevance indicator indicating that the first display and the second display have relevance to each other on the display unit.

6. The information processing system according to claim 2, wherein the processor is configured to:
display a relevance indicator indicating that the first display and the second display have relevance to each other on the display unit.

7. The information processing system according to claim 5,
wherein the relevance indicator is a figure that connects the first display and the second display.

8. The information processing system according to claim 6,
wherein the relevance indicator is a figure that connects the first display and the second display.

9. The information processing system according to claim 1, wherein the processor is configured to:
in a case in which a first operation for confirming a content of the first function based on the first display and a second operation for confirming a content of the second function based on the second display are executed, confirm the content of the first function and the content of the second function.

10. The information processing system according to claim 2, wherein the processor is configured to:
in a case in which a first operation for confirming a content of the first function based on the first display and a second operation for confirming a content of the second function based on the second display are executed, confirm the content of the first function and the content of the second function.

11. The information processing system according to claim 9, wherein the processor is configured to:
allow the first operation to be executed after the second operation is executed.

12. The information processing system according to claim 10, wherein the processor is configured to:
allow the first operation to be executed after the second operation is executed.

13. A non-transitory computer readable medium storing a program causing a computer to execute a process comprising:
simultaneously displaying at least a part of first displays for setting a first function in a target machine and at least a part of second displays for setting a second function of notifying a user of the target machine of information regarding the first function, on a display unit.

14. An information processing method comprising:
simultaneously displaying at least a part of first displays for setting a first function in a target machine and at least a part of second displays for setting a second function of notifying a user of the target machine of information regarding the first function, on a display unit.
